(19) United States
(12) Patent Application Publication
(10) Pub. No.: US 2014/0088813 A1
(43) Pub. Date: Mar. 27, 2014

(54) CONTROL DEVICE

(71) Applicants: Yasuhiko Kobayashi, Anjo (JP); Yuma Mori, Kota (JP); Yomei Hakumura, Susono (JP)

(72) Inventors: Yasuhiko Kobayashi, Anjo (JP); Yuma Mori, Kota (JP); Yomei Hakumura, Susono (JP)

(73) Assignee: AISIN AW CO., LTD., Anjo-shi, Aichi-ken (JP)

(21) Appl. No.: 14/122,130

(22) PCT Filed: Aug. 8, 2012
(86) PCT No.: PCT/JP2012/070252

§ 371 Date: Nov. 25, 2013

(30) Foreign Application Priority Data
Aug. 8, 2011 (JP) 2011-173219

(51) Int. Cl. B60W 20/00; B60W 10/08; B60W 10/02

(52) U.S. Cl. CPC B60W 20/20; B60W 10/02; B60W 10/08; B60W 2600/00; Y10S 903/93
USPC 701/22; 180/65.265; 903/930

(57) ABSTRACT

A control device for a vehicle drive configured with a power transfer path that includes a first engagement device, a rotary electric machine, and a second engagement device. These elements being arranged in this order from an input member coupled to an engine to an output member that is coupled to the wheels of the vehicle. The control device executes mode shift control from a first control mode to a third control mode via a second control mode. The first, second and third control modes being modes in which the rotating electrical machine generates electricity with: (i) both the first and second engagement devices in a direct engagement state, (ii) the first engagement device in the direct engagement state and the second engagement device in the slip engagement state, and (iii) both the first and second engagement devices in a slip engagement state.

### INCORPORATION BY REFERENCE

The disclosure of Japanese Patent Application No. 2011-173219 filed on Aug. 8, 2011 including the specification, drawings and abstract is incorporated herein by reference in its entirety.

### BACKGROUND OF THE INVENTION

The present invention relates to control devices that control a vehicle drive device in which a first engagement device, a rotating electrical machine, a second engagement device, and an output member are sequentially provided from the internal combustion engine side on a power transmission path connecting an internal combustion engine and wheels.

### DESCRIPTION OF THE RELATED ART

A control device disclosed in, e.g., Japanese Patent Application Publication No. 2008-7094 (JP 2008-7094 A) is already known as the control devices that control a vehicle drive device. The names of the members in JP 2008-7094 A are referred to in parentheses “[ ]” in the description of the section “Description of the Related Art.” The control device of JP 2008-7094 A [controllers 1, 2, 5, 7, 10, etc.] can implement a plurality of drive modes by controlling a vehicle drive device. The plurality of drive modes include a WSC creep mode, a CL2 overheat mode, and a WSC positive power generation mode.

In the WSC creep mode, the control device causes a vehicle to creep by the torque of the internal combustion engine [engine E] with the first engagement device [first clutch CL1] being in a direct engagement state and the second engagement device [second clutch CL2] being in a slip engagement state. In the CL2 overheat mode, the control device causes the vehicle to creep by the torque of the internal combustion engine with both the first engagement device and the second engagement device being in the slip engagement state. In the WSC positive power generation mode, the control device causes the vehicle to move and causes the rotating electrical machine [motor generator MG] to generate electricity with the first engagement device being in the direct engagement state and the second engagement device being in the slip engagement state. The control device can switch between the WSC creep mode and the CL2 overheat mode or between the WSC creep mode and the WSC positive power generation mode (see FIG. 6 etc. of JP 2008-7094 A).

During low-speed traveling with a small amount of electricity being stored in an electricity storage device [battery 4], the control device of JP 2008-7094 A implements the WSC positive power generation mode in order to cause the rotating electrical machine to generate electricity. In the WSC positive power generation mode, however, since only the second engagement device is in the slip engagement state, the differential rotational speed between engagement members on both sides of the second engagement device is large for a long time. Accordingly, the heat generation amount of the second engagement device increases, which may cause overheat of the second engagement device. That is, in a specific traveling state such as during low-speed traveling, it is difficult to secure a desired amount of electricity while suppressing the heat generation amount of the second engagement device.

On the other hand, even during low-speed traveling, the differential rotational speed between the engagement members on both sides of the second engagement device is relatively small and the possibility that the second engagement device may overheat is relatively low, if the vehicle speed is somewhat high. Accordingly, there are cases where it is better to prioritize achievement of other effects regarding traveling of the vehicle, such as the overall heat generation amount of the two engagement devices, power generation efficiency of the rotating electrical machine, or reduction in shock that is transmitted to the vehicle, over suppression of overheat of only the second engagement device. JP 2008-7094 A does not particularly recognize these points.

### SUMMARY OF THE INVENTION

It is therefore desired to implement a control device capable of securing a desired amount of electricity while suppressing the power generation amount of a second engagement device in a specific traveling state such as during low-speed traveling, and capable of implementing a desired traveling state according to the situation.

According to an aspect of the present invention, a control device that controls a vehicle drive device in which a first engagement device, a rotating electrical machine, a second engagement device, and an output member are sequentially provided from an internal combustion engine side on a power transmission path connecting an internal combustion engine and wheels. The control device executes mode shift control of shifting a mode from a first control mode in which the rotating electrical machine is caused to generate electricity with both the first engagement device and the second engagement device in a direct engagement state to a third control mode in which the rotating electrical machine is caused to generate electricity with both the first engagement device and the second engagement device in a slip engagement state via a second control mode in which the rotating electrical machine is caused to generate electricity with the first engagement device in the direct engagement state and the second engagement device in the slip engagement state.

The “rotating electrical machine” is used as a concept including all of a motor (electric motor), a generator (electric generator), and a motor-generator that functions both as the motor and the generator as necessary.

The “direct engagement state” represents the state where engagement members on both sides of a specific engagement device are engaged so as to rotate together. The “slip engagement state” represents the state where the engagement members on both sides are engaged so that a driving force can be transmitted therebetween with a rotational speed difference therebetween. The “disengagement state” represents the state where neither rotation nor the driving force is transmitted between the engagement members on both sides.

According to the above configuration, even if the vehicle speed decreases to a predetermined speed or less during traveling in the first control mode, the second engagement device is brought into the slip engagement state in the second control mode, whereby the vehicle can be moved while driving the internal combustion engine at a rotational speed that allows the internal combustion engine to continue self-sustained operation. In this case, since the second engagement device is brought into the slip engagement state, the rotational speed of the rotating electrical machine can be kept higher than that according to the rotational speed of the output member. Thus, the rotating electrical machine rotating at such a rotational speed is caused to generate electricity, and a desired amount of electricity can be secured. Since the first engagement device is kept in the direct engagement state from the first control mode to the second control mode, torque of the internal combustion engine is transmitted to the rotating electrical machine side with slight loss, and power generation efficiency of the rotating electrical machine can be improved. Moreover, as compared to the case where both the first engagement device and the second engagement device are brought into the slip engagement state as in, e.g., the third control mode, a differential rotational speed between engagement members on both sides of the first engagement device having relatively large transfer torque is made equal to zero, and the overall heat generation amount of the two engagement devices can be reduced.

In the above configuration, both the first engagement device and the second engagement device are brought into the slip engagement state in the third control mode. Accordingly, as compared to the case where the first engagement device is brought into the direct engagement state and the second engagement device is brought into the slip engagement state as in, e.g., the second control mode, a differential rotational speed between engagement members on both sides of the second engagement device can be reduced, whereby the heat generation amount of the engagement members of the second engagement devices can be suppressed. Since the second engagement device is in the slip engagement state in the third control mode as well, the rotational speed of the rotating electrical machine can be kept higher than that according to the rotational speed of the output member, and a desired amount of electricity can be secured. The mode can be appropriately shifted from the first control mode to the second control mode and from the second control mode to the third control mode according to the situation by execution of the mode shift control. The first engagement device is transitioned from the direct engagement state to the slip engagement state in the mode shift from the second control mode to the third control mode. This state transition of the first engagement device is made with the second engagement device being in the slip engagement state. This can suppress transmission of shock in the state transition to the vehicle.

In the third control mode, transfer torque of the second engagement device in the slip engagement state may be controlled so that torque according to a requested driving force for driving the wheels is transferred, and a rotational speed of the rotating electrical machine may be controlled by using as a target rotational speed a rotational speed that is obtained by adding a predetermined differential rotational speed to a converted rotational speed obtained by converting a rotational speed of the output member to a rotational speed obtained when the rotational speed of the output member is transmitted to the rotating electrical machine on an assumption that the second engagement device is in the direct engagement state.

According to this configuration, the torque according to the requested driving force can be transferred to the output member side via the second engagement device in the slip engagement state in the third control mode, whereby the requested driving force can be appropriately satisfied. The rotational speed of the rotating electrical machine is controlled by using as the target rotational speed the rotational speed that is higher than the converted rotational speed according to the rotational speed of the output member by the predetermined set differential rotational speed. Accordingly, the slip engagement state of the second engagement device can be appropriately implemented.

If a temperature of the second engagement device becomes equal to or higher than a predetermined high-temperature determination threshold in the third control mode, the rotational speed of the rotating electrical machine may be controlled so as to decrease a differential rotational speed between the converted rotational speed obtained by converting the rotational speed of the output member to the rotational speed obtained when the rotational speed of the output member is transmitted to the rotating electrical machine on the assumption that the second engagement device is in the direct engagement state and the rotational speed of the rotating electrical machine.

According to this configuration, it can be detected based on the relation between the temperature of the second engagement device and the high-temperature determination threshold value that the second engagement device is getting closer to an overheat condition. If such a state is detected, the differential rotational speed between the engagement members on both sides of the second engagement device can be reduced, and the heat generation amount of the second engagement device can be reduced. This can reduce the possibility that the temperature of the second engagement device may further increase beyond the high-temperature determination threshold, whereby overheat of the second engagement device can be suppressed.

The differential rotational speed may be reduced as the temperature of the second engagement device increases beyond the high-temperature determination threshold.

According to this configuration, an increase in temperature of the second engagement device can be more effectively suppressed as an amount by which the temperature of the second engagement device exceeds the high-temperature determination threshold increases. In this configuration, in the case where the amount by which the temperature of the second engagement device exceeds the high-temperature determination threshold is relatively small, an amount of decrease in the differential rotational speed decreases according to the exceeding amount. Accordingly, the differential rotational speed between the engagement members on both sides of the second engagement device is increased in such a range that overheat of the second engagement device does not particularly cause any problem, whereby an overall heat generation amount of the two engagement devices can be reduced.

### BRIEF DESCRIPTION OF THE DRAWINGS

FIG. 1 is a schematic diagram showing a schematic configuration of a vehicle drive device and a control device thereof according to an embodiment;

FIG. 2 is a table showing drive modes that can be implemented by the control device;

FIG. 3 is a timing chart showing an example of the operating state of each part when power generation/stop control is executed;

FIG. 4 is a flowchart showing procedures of the power generation/stop control;

FIG. 5 is a timing chart showing another example of the operating state of each part when the power generation/stop control is executed; and

FIG. 6 is a flowchart showing procedures of overheat avoidance control.

### DETAILED DESCRIPTION OF THE EMBODIMENTS

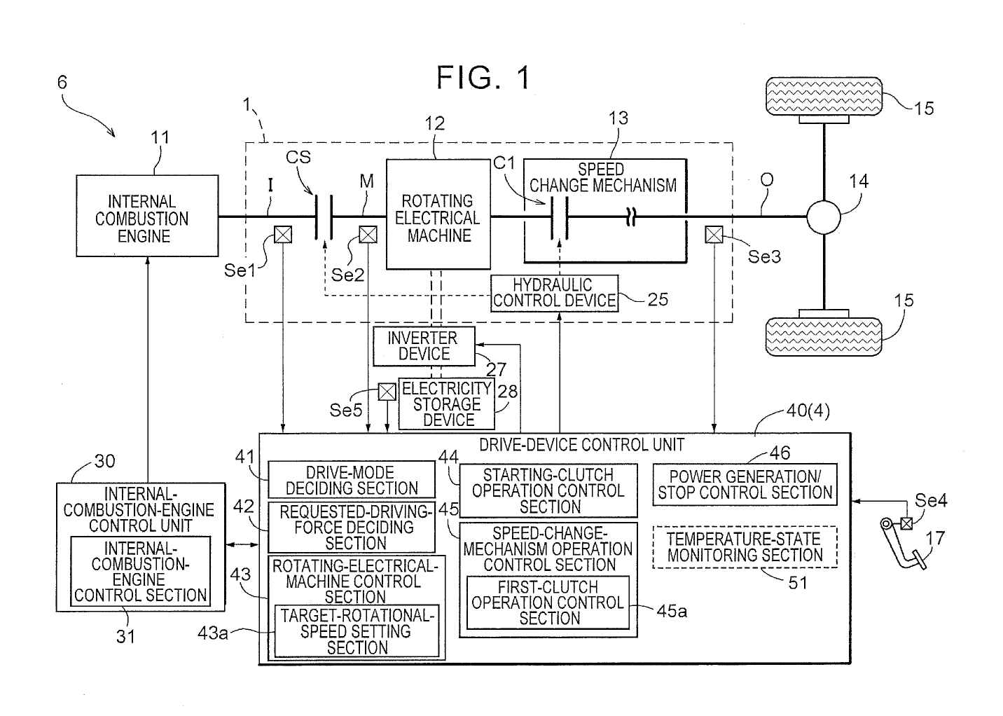

An embodiment of a control device according to the present invention will be described with reference to the accompanying drawings. As shown in FIG. 1, a control device 4 according to the present embodiment is a control device for drive devices which controls a drive device 1 that drives a vehicle (hybrid vehicle) 6 including both an internal combustion engine 11 and a rotating electrical machine 12. The drive device 1 and the control device 4 according to the present embodiment will be described in order.

In the following description, the expression “drivingly coupled” refers to the state where two rotating elements are coupled together so that a driving force can be transmitted therebetween, and is used as a concept including the state where the two rotating elements are coupled together so as to rotate together, or the state where the two rotating elements are coupled together so that the driving force can be transmitted therebetween via one or more transmission members. Such transmission members include various members that transmit rotation at the same speed or at a shifted speed (e.g., a shaft, a gear mechanism, a belt, a chain, etc.). The term “driving force” is herein used as a synonym for “torque.”

The “engagement pressure” for each engagement device represents the pressure that presses one engagement member of the engagement device against the other engagement member thereof by, e.g., a hydraulic servo mechanism etc. The “disengagement pressure” represents the pressure that allows the engagement device to be steadily in a disengagement state. The “disengagement boundary pressure” represents the pressure that brings the engagement device into a slip boundary state as the boundary between the disengagement state and a slip engagement state (disengagement-side slip boundary pressure). The “engagement boundary pressure” represents the pressure that brings the engagement device into a slip boundary state as the boundary between the slip engagement state and a direct engagement state (engagement-side slip boundary pressure). The “full engagement pressure” represents the pressure that allows the engagement device to be steadily in the direct engagement state.

### 1. Configuration of Drive Device

The drive device 1 that is controlled by the control device 4 according to the present embodiment is configured as a drive device for so-called single-motor parallel hybrid vehicles. As shown in FIG. 1, this drive device 1 includes a starting clutch CS, a rotating electrical machine 12, a speed change mechanism 13, and an output shaft O sequentially from the side of an internal combustion engine 11 and an input shaft I on a power transmission path that connects the input shaft I drivingly coupled to the internal combustion engine 11 and the output shaft O drivingly coupled to wheels 15. The speed change mechanism 13 is provided with a first clutch C1 for shifting, as described below. Thus, the starting clutch CS, the rotating electrical machine 12, the first clutch C1, and the output shaft O are sequentially provided from the input shaft I side on the power transmission path connecting the input shaft I and the output shaft O. These elements are accommodated in a case (drive device case). In the present embodiment, the output shaft O corresponds to the “output member” in the present invention.

The internal combustion engine 11 is a motor that is driven by fuel combustion in the engine to output power. For example, a gasoline engine, a diesel engine, etc. can be used as the internal combustion engine 11. The internal combustion engine 11 is drivingly coupled to the input shaft I so as to rotate together therewith. In this example, an output shaft such as a crankshaft of the internal combustion engine 11 is drivingly coupled to the input shaft I. The internal combustion engine 11 is drivingly coupled to the rotating electrical machine 12 via the starting clutch CS.

The starting clutch CS is capable of releasing the driving coupling between the internal combustion engine 11 and the rotating electrical machine 12. The starting clutch CS is a friction engagement device that selectively drivingly couples the input shaft I to an intermediate shaft M and the output shaft O, and functions as an internal-combustion-engine cut-off clutch. A wet multi-plate clutch, a dry single-plate clutch, etc. can be used as the starting clutch CS. In the present embodiment, the starting clutch CS corresponds to the “first engagement device” in the present invention.

The rotating electrical machine 12 has a rotor and a stator (not shown), and can function as a motor (electric motor) and a generator (electric generator). The rotor of the rotating electrical machine 12 is drivingly coupled to the intermediate shaft M so as to rotate together therewith. The rotating electrical machine 12 is electrically connected to an electricity storage device 28 via an inverter device 27. A battery, a capacitor, etc. can be used as the electricity storage device 28. The rotating electrical machine 12 is supplied with electric power from the electricity storage device 28 to perform power running, or supplies the electric power generated by the output torque of the internal combustion engine 11 (internal-combustion-engine torque Te) or the inertia force of the vehicle 6 to the electricity storage device 28 to store the electric power therein. The intermediate shaft M is drivingly coupled to the speed change mechanism 13. That is, the intermediate shaft M as an output shaft of the rotor of the rotating electrical machine 12 (rotor output shaft) is an input shaft of the speed change mechanism 13 (shift input shaft).

The speed change mechanism 13 is an automatic stepped speed change mechanism that enables switching between shift speeds with different speed ratios. The speed change mechanism 13 includes a gear mechanism such as a planetary gear mechanism, and a plurality of engagement devices (in this example, friction engagement devices) such as a clutch and a brake which engage or disengage a rotating element of the gear mechanism, in order to form the plurality of shift speeds. A wet multi-plate clutch etc. can be used as the plurality of engagement devices. In the present embodiment, the plurality of engagement devices include the first clutch C1, and include other clutches, brakes, etc. In the present embodiment, the first clutch C1 corresponds to the “second engagement device” in the present invention.

The speed change mechanism 13 shifts the rotational speed of the intermediate shaft M and converts the torque thereof, based on the speed ratio that has been set for each shift speed that is formed according to the engagement states of the plurality of engagement devices for shifting, and transmits the shifted rotational speed and the converted torque to the output shaft O as an output shaft of the speed change mechanism 13 (shift output shaft). The “speed ratio” is the ratio of the rotational speed of the intermediate shaft M (shift input shaft) to that of the output shaft O (shift output shaft). The torque transferred from the speed change mechanism 13 to the output shaft O is distributed and transferred to the two right and left wheels 15 via an output differential gear unit 14. The drive device 1 can thus transfer the torque of one or both of the internal combustion engine 11 and the rotating electrical machine 12 to the wheels 15 to move the vehicle 6.

In the present embodiment, the drive device 1 includes a mechanical oil pump (not shown) drivingly coupled to the intermediate shaft M. The oil pump is driven and operated by the driving force of one or both of the rotating electrical machine 12 and the internal combustion engine 11, and generates an oil pressure. Oil from the oil pump is adjusted to a predetermined oil pressure by a hydraulic control device 25, and is then supplied to the starting clutch CS, the first clutch C1, etc. The drive device 1 may include an electric oil pump in addition to this oil pump.

As shown in FIG. 1, each part of the vehicle 6 is provided with a plurality of sensors Se1 to Se5. The input-shaft rotational speed sensor Se1 is a sensor that detects the rotational speed of the input shaft I. The rotational speed of the input shaft I which is detected by the input-shaft rotational speed sensor Se1 is equal to that of the internal combustion engine 11. The intermediate-shaft rotational speed sensor Se2 is a sensor that detects the rotational speed of the intermediate shaft M. The rotational speed of the intermediate shaft M which is detected by the intermediate-shaft rotational speed sensor Se2 is equal to that of the rotor of the rotating electrical machine 12. The output-shaft rotational speed sensor Se3 is a sensor that detects the rotational speed of the output shaft O. The control device 4 can derive the vehicle speed as the traveling speed of the vehicle 6, based on the rotational speed of the output shaft O which is detected by the output-shaft rotational speed sensor Se3.

The accelerator-operation-amount detection sensor Se4 is a sensor that detects the accelerator operation amount by detecting the amount by which the accelerator pedal 17 is operated. The state-of-charge detection sensor Se5 is a sensor that detects the state of charge (SOC). The control device 4 can derive the amount of electricity stored in the electricity storage device 28, based on the SOC that is detected by the state-of-charge detection sensor Se5. Information on the detection results of the sensors Se1 to Se5 is output to the control device 4.

### 2. Configuration of Control Device

As shown in FIG. 1, the control device 4 according to the present embodiment includes a drive-device control unit 40. The drive-device control unit 40 mainly controls the rotating electrical machine 12, the starting clutch CS, and the speed change mechanism 13. In addition to the drive-device control unit 40, the vehicle 6 includes an internal-combustion-engine control unit 30 that mainly controls the internal combustion engine 11.

The internal-combustion-engine control unit 30 and the drive-device control unit 40 can receive and send information from and to each other. Function units included in the internal-combustion-engine control unit 30 and the drive-device control unit 40 can receive and send information from and to each other. The internal-combustion-engine control unit 30 and the drive-device control unit 40 can obtain information on the detection results of the sensors Se1 to Se5.

The internal-combustion-engine control unit 30 includes an internal-combustion-engine control section 31. The internal-combustion-engine control section 31 is a function section that controls operation of the internal combustion engine 11. The internal-combustion-engine control section 31 decides target torque and a target rotational speed as control targets of the internal-combustion-engine torque Te and the rotational speed, and operates the internal combustion engine 11 according to the control targets. In the present embodiment, the internal-combustion-engine control section 31 can switch between torque control and rotational speed control of the internal combustion engine 11 according to the traveling speed of the vehicle 6. The torque control is the control of sending a command of target torque to the internal combustion engine 11 to cause the internal-combustion-engine torque Te to follow (to be closer to) the target torque. The rotational speed control is the control of sending a command of a target rotational speed to the internal combustion engine 11 and deciding target torque so as to cause the rotational speed of the internal combustion engine 11 to follow the target rotational speed.

The drive-device control unit 40 includes a drive-mode deciding section 41, a requested-driving-force deciding section 42, a rotating-electrical-machine control section 43, a starting-clutch operation control section 44, a speed-change-mechanism operation control section 45, and a power generation/stop control section 46.

The drive-mode deciding section 41 is a function section that decides the drive mode of the vehicle 6. The drive-mode deciding section 41 decides the drive mode to be implemented by the drive device 1 by referring to a predetermined map (mode selection map), etc. based on, e.g., the vehicle speed, the accelerator operation amount, the amount of electricity stored in the electricity storage device 28, etc.

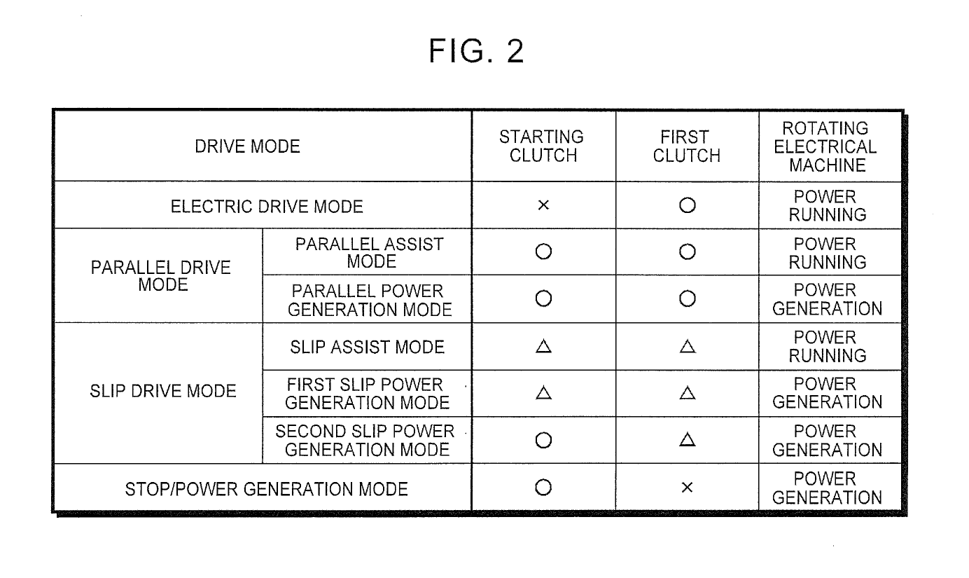

As shown in FIG. 2, in the present embodiment, the drive modes that can be selected by the drive-mode deciding section 41 include an electric drive mode, a parallel drive mode, a slip drive mode, and a stop/power generation mode. The parallel drive mode includes a parallel assist mode and a parallel power generation mode. The slip drive mode includes a slip assist mode, a first slip power generation mode, and a second slip power generation mode. In FIG. 2, “◯” means that the clutch CS, C1 is in the direct engagement state, “Δ” means that the clutch CS, C1 is in the slip engagement state, and “x” means that the clutch CS, C1 is in the disengagement state. For the rotating electrical machine 12, “power running” means that the rotating electrical machine 12 provides torque assist for the vehicle 6 or is merely idling.

As shown in FIG. 2, in the electric drive mode, the rotating electrical machine 12 performs power running with the starting clutch CS in the disengagement state and the first clutch C1 in the direct engagement state. The control device 4 selects the electric drive mode to move the vehicle 6 only by the output torque of the rotating electrical machine 12 (rotating-electrical-machine torque Tm). In the parallel drive mode, the rotating electrical machine 12 performs power running or generates electricity with both the starting clutch CS and the first clutch C1 in the direct engagement state. The control device 4 selects the parallel drive mode to move the vehicle 6 by at least the internal-combustion-engine torque Te. In this case, the rotating electrical machine 12 performs power running to supplement the driving force that is produced by the internal-combustion-engine torque Te in the parallel assist mode, and generates electricity by the internal-combustion-engine torque Te in the parallel power generation mode.

In the slip assist mode, the rotating electrical machine 12 performs power running with both the starting clutch CS and the first clutch C1 in the slip engagement state. The control device 4 selects the slip assist mode to move the vehicle 6 by at least the internal-combustion-engine torque Te. In the first slip power generation mode, the rotating electrical machine 12 generates electricity with both the starting clutch CS and the first clutch C1 in the slip engagement state. In the second slip power generation mode, the rotating electrical machine 12 generates electricity with the starting clutch CS in the direct engagement state and the first clutch C1 in the slip engagement state. The control device 4 selects one of these two slip power generation modes to move the vehicle 6 while causing the rotating electrical machine 12 to generate electricity by using the internal-combustion-engine torque Te. In the stop/power generation mode, the rotating electrical machine 12 generates electricity with the starting clutch CS in the direct engagement state and the first clutch C1 in the disengagement state. The control device 4 selects the stop/power generation mode to cause the rotating electrical machine 12 to generate electricity by the internal-combustion-engine torque Te with the vehicle 6 stopped.

In the present embodiment, the first slip power generation mode corresponds to the “third control mode” in the present invention, the second slip power generation mode corresponds to the “second control mode” in the present invention, and the parallel power generation mode corresponds to the “first control mode” in the present invention. The present invention may be configured so that only some of the drive modes including at least the first slip power generation mode, the second slip power generation mode, and the parallel power generation mode can be selected, or the drive mode or modes other than these can be additionally selected.

The requested-driving-force deciding section 42 is a function section that decides a requested driving force Td that is required to drive the wheels 15 to move the vehicle 6. The requested-driving-force deciding section 42 decides the requested driving force Td by referring to a predetermined map (requested-driving-force decision map), etc. based on the vehicle speed and the accelerator operation amount. The requested driving force Td thus decided is output to the internal-combustion-engine control section 31, the rotating-electrical-machine control section 43, the power generation/stop control section 46, etc.

The rotating-electrical-machine control section 43 is a function section that controls operation of the rotating electrical machine 12. The rotating-electrical-machine control section 43 controls operation of the rotating electrical machine 12 by deciding target torque and a target rotational speed as control targets of the rotating-electrical-machine torque Tm and the rotational speed), and operating the rotating electrical machine 12 according to the control targets. In the present embodiment, the rotating-electrical-machine control section 43 can switch between torque control and rotational speed control of the rotating electrical machine 12 according to the traveling state of the vehicle 6. The torque control is the control of sending a command of target torque to the rotating electrical machine 12 to cause the rotating-electrical-machine torque Tm to follow the target torque. The rotational speed control is the control of sending a command of a target rotational speed Nmt to the rotating electrical machine 12 and deciding target torque so as to cause the rotational speed of the rotating electrical machine 12 to follow the target rotational speed Nmt. The rotating-electrical-machine control section 43 includes a target-rotational-speed setting section 43a as a function section that sets the target rotational speed Nmt.

The starting-clutch operation control section 44 is a function section that controls operation of the starting clutch CS. The starting-clutch operation control section 44 controls operation of the starting clutch CS by controlling an oil pressure that is supplied to the starting clutch CS via the hydraulic control device 25, and controlling an engagement pressure of the starting clutch CS. For example, the starting-clutch operation control section 44 outputs an oil pressure command to the starting clutch CS, and sets an oil pressure to be supplied to the starting clutch CS to the disengagement pressure according to the oil pressure command so that the starting clutch CS is steadily in the disengagement state. The starting-clutch operation control section 44 sets an oil pressure to be supplied to the starting clutch CS to the full engagement pressure so that the starting clutch CS is steadily in the direct engagement state. The starting-clutch operation control section 44 sets an oil pressure to be supplied to the starting clutch CS to a slip engagement pressure equal to or higher than the disengagement boundary pressure and less than the engagement boundary pressure so that the starting clutch CS is brought into the slip engagement state.

When the starting clutch CS is in the slip engagement state, the input shaft I and the intermediate shaft M rotate relative to each other, and the driving force is transmitted therebetween. The magnitude of the torque that can be transferred when the starting clutch CS is in the direct engagement state or the slip engagement state is determined according to the engagement pressure of the starting clutch CS at that time. The magnitude of the torque at this time is the “transfer torque capacity” of the starting clutch CS. The “transfer torque” of the starting clutch CS is determined according to the transfer torque capacity. In the present embodiment, increase or decrease in engagement pressure and transfer torque capacity can be continuously controlled by continuously controlling the amount of oil and the magnitude of oil pressure to be supplied to the starting clutch CS by a proportional solenoid etc. according to an oil pressure command to the starting clutch CS. The direction in which the torque is transferred via the starting clutch CS in the slip engagement state is determined according to the direction of the relative rotation between the input shaft I and the intermediate shaft M.

The starting-clutch operation control section 44 can switch between torque control and rotational speed control of the starting clutch CS according to the traveling state of the vehicle 6. The torque control is the control of sending a command of target transfer torque capacity to the starting clutch CS to cause the transfer torque (transfer torque capacity) of the starting clutch CS to follow the target transfer torque capacity. The rotational speed control is the control of deciding an oil pressure command for the starting clutch CS or target transfer torque capacity of the starting clutch CS so as to cause the differential rotational speed between the rotating member (in this example, the intermediate shaft M) coupled to one engagement member of the starting clutch CS and the rotating member (in this example, the input shaft I) coupled to the other engagement member of the starting clutch CS to follow a predetermined target differential rotational speed. In the rotational speed control of the starting clutch CS, if the rotational speed of the intermediate shaft M is determined, the rotational speed of the input shaft I is also determined if the differential rotational speed becomes equal to the target differential rotational speed. Accordingly, the rotational speed control of the starting clutch CS is also the control of sending a command of a target rotational speed of the input shaft I and deciding an oil pressure command for the starting clutch CS or target transfer torque capacity of the starting clutch CS so as to cause the rotational speed of the input shaft Ito follow the target rotational speed.

The speed-change-mechanism operation control section 45 is a function section that controls operation of the speed change mechanism 13. The speed-change-mechanism operation control section 45 decides a target shift speed by referring to a predetermined map (shift map), etc. based on the accelerator operation amount and the vehicle speed. The speed-change-mechanism operation control section 45 controls, based on the decided target shift speed, an oil pressure to be supplied to a predetermined clutch, brake, etc. included in the speed change mechanism 13, thereby forming the target shift speed.

In this example, the first clutch C1 included in the speed change mechanism 13 cooperates with a second brake included in the speed change mechanism 13 to form a first shift speed. A first-clutch operation control section 45a in the speed-change-mechanism operation control section 45 is a function section that controls operation of the first clutch C1. The first-clutch operation control section 45a controls an oil pressure to be supplied to the first clutch C1 via the hydraulic control device 25, and controls operation of the first clutch C1 by controlling the engagement pressure of the first clutch C1. The operation control of the first clutch C1 by the first-clutch operation control section 45a is basically similar to that of the starting clutch CS by the starting-clutch operation control section 44 except that the object to be controlled and matters associated therewith are partially different those of the operation control of the starting clutch CS by the starting-clutch operation control section 44.

The power generation/stop control section 46 is a function section that executes power generation/stop control. The power generation/stop control section 46 executes power generation/stop control by cooperative control of the internal-combustion-engine control section 31, the rotating-electrical-machine control section 43, the starting-clutch operation control section 44, the first-clutch operation control section 45a, etc., thereby stopping the vehicle 6 while causing the rotating electrical machine 12 to generate electricity. The contents of the power generation/stop control that is executed by the power generation/stop control section 46 as a core will be described in detail below.

### 3. Contents of Power Generation/Stop Control

The power generation/stop control is triggered by, e.g., the state where the vehicle 6 is brought into the low vehicle-speed state during traveling in the parallel drive mode (in this example, the parallel power generation mode) and in the accelerator-off state. As used herein, the “low vehicle-speed state” refers to the state where an estimated rotational speed of the input shaft I, which is estimated on the assumption that both the starting clutch CS and the first clutch C1 are in the direct engagement state at the shift speed with the maximum speed ratio (in this example, the first speed) being formed in the speed change mechanism 13, is less than a low vehicle-speed determination threshold value (low vehicle-speed determination threshold) X1. The internal combustion engine 11 drivingly coupled to the input shaft I so as to rotate together therewith needs to rotate at a certain speed or more in order to output predetermined internal-combustion-engine torque Te and continue self-sustained operation. In this example, the low vehicle-speed determination threshold value X1 is set as a rotational speed that allows the internal combustion engine 11 to continue self-sustained operation with some margin.

The power generation/stop control section 46 executes power generation/stop control while the vehicle 6 is in the low vehicle-speed state. In the present embodiment, the power generation/stop control section 46 shifts the drive mode of the vehicle 6 from the parallel power generation mode to the second slip power generation mode in the power generation/stop control. The power generation/stop control section 46 first causes the rotating electrical machine 12 to generate electricity with both the starting clutch CS and the first clutch C1 in the direct engagement state, and then causes the rotating electrical machine 12 to generate electricity with the starting clutch CS in the direct engagement state and the first clutch C1 in the slip engagement state.

Moreover, in the present embodiment, the power generation/stop control section 46 shifts the drive mode of the vehicle 6 from the second slip power generation mode to the first slip power generation mode particularly while the vehicle 6 is in a specific low vehicle-speed state of the low vehicle-speed state. The power generation/stop control section 46 causes the rotating electrical machine 12 to generate electricity with the starting clutch CS in the direct engagement state and the first clutch C1 in the slip engagement state, and then causes the rotating electrical machine 12 to generate electricity with both the starting clutch CS and the first clutch C1 in the slip engagement state when the vehicle speed decreases and the vehicle 6 is brought into the specific low vehicle-speed state. In the present embodiment, the power generation/stop control corresponds to the “mode shift control” in the present invention.

As used herein, the “specific low vehicle-speed state” refers to the state in which an estimated rotational speed of the input shaft I, which is estimated on the assumption that both the starting clutch CS and the first clutch C1 are in the direct engagement state at the shift speed with the maximum speed ratio being formed in the speed change mechanism 13, is less than a specific low vehicle-speed determination threshold value (specific low vehicle-speed determination threshold) X2 that is set to a value smaller than the low vehicle-speed determination threshold value X1. As described above, the internal combustion engine 11 needs to rotate at a certain speed or more in order to continue self-sustained operation. The internal combustion engine 11 also needs to rotate at the certain speed or more in order to suppress generation of booming noise and vibrations. In this example, the specific low vehicle-speed determination threshold value X2 is set in view of these points. The specific low vehicle-speed determination threshold value X2 may be set with a predetermined amount of margin.

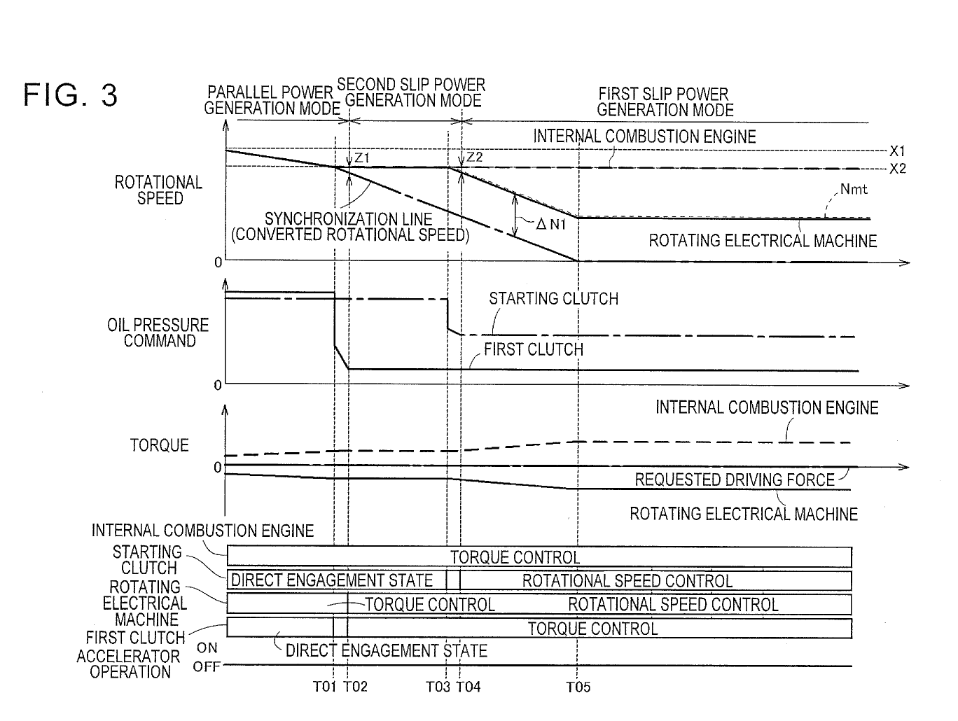

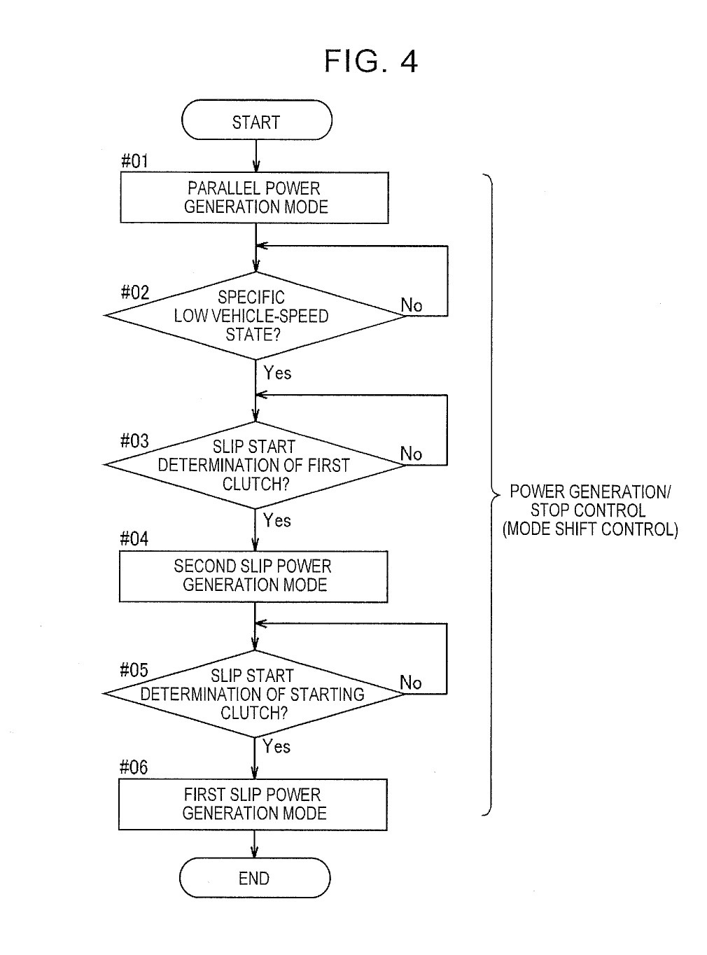

The contents of the power generation/stop control will be described in more detail with reference to FIGS. 3 and 4. In the following description, each function section performs processing based on a command from the power generation/stop control section 46. It is herein assumed that the first speed is formed in the speed change mechanism 13.

In this example, in the initial state, the parallel power generation mode is implemented, and the vehicle 6 is traveling with the rotating electrical machine 12 generating electricity by the internal-combustion-engine torque Te (up to time T01, step #01). In the parallel power generation mode, both the starting clutch CS and the first clutch C1 are in the direct engagement state. Torque control of the internal combustion engine 11 and torque control of the rotating electrical machine 12 are executed.

More specifically, the rotating-electrical-machine control section 43 performs torque control of the rotating electrical machine 12 by using torque required to generate a predetermined target power generation amount (negative torque) as target torque. The target power generation amount is decided based on rated power consumption or actual power consumption of accessories that are provided in the vehicle 6 and that are driven by using electric power (e.g., a compressor of an on-vehicle air conditioner, lamps, etc.), etc., and as necessary, based on the amount of electricity stored in the electricity storage device 28, etc. The torque required to generate the target power generation amount is obtained according to the rotational speed of the rotating electrical machine 12 which is determined according to the vehicle speed, by dividing the target power generation amount by this rotational speed and changing the sign of the quotient.

The internal-combustion-engine control section 31 performs torque control of the internal combustion engine 11 by using as target torque the torque obtained by adding the torque according to the requested driving force Td and the torque used to cause the rotating electrical machine 12 to generate electricity. The torque according to the requested driving force Td is obtained by dividing the requested driving force Td by the speed ratio of the first speed. The torque used to cause the rotating electrical machine 12 to generate electricity is positive torque whose magnitude (absolute value) is equal to that of the target torque of the rotating electrical machine 12. In the illustrated example, the requested driving force Td is substantially zero. Accordingly, the internal-combustion-engine control section 31 performs torque control of the internal combustion engine 11 by substantially using the torque used to cause the rotating electrical machine 12 to generate electricity as the target torque.

If the specific low vehicle-speed state is detected at time T01 in the parallel power generation mode (step #02: Yes), the drive mode is shifted from the parallel power generation mode to the second slip power generation mode. In this mode shift, the first-clutch operation control section 45a gradually decreases an oil pressure that is supplied to the first clutch C1 (time T01 to T02). Slip start determination of the first clutch C1 is made in the state where the oil pressure that is supplied to the first clutch C1 is being gradually decreased (step #03).

The power generation/stop control section 46 makes slip start determination of the first clutch C1 based on whether or not the differential rotational speed between the rotational speed of the intermediate shaft M according to the rotational speed of the output shaft O in the case where it is assumed that the first speed is formed in the speed change mechanism 13 (in this case, at least the first clutch C1 is in the direct engagement state) (in the present embodiment, this rotational speed of the intermediate shaft M is referred to as the “converted rotational speed Noc”) and the rotational speed of the internal combustion engine 11 and the rotating electrical machine 12 becomes equal to or higher than a first slip start determination threshold value (first slip start determination threshold) Z1. The converted rotational speed Noc is an estimated rotational speed (also shown as “synchronization line” in FIG. 3) that is obtained by converting the rotational speed No of the output shaft O to the rotational speed obtained when the rotational speed No is transmitted to the rotating electrical machine 12 on the assumption that the first speed is formed. Specifically, the converted rotational speed Noc is an estimated rotational speed obtained by multiplying the rotational speed No of the output shaft O by the speed ratio of the first speed. If the differential rotational speed becomes equal to or higher than the first slip start determination threshold value Z1 at time T02 (step #03: Yes), the mode shift from the parallel power generation mode to the second slip power generation mode is completed (step #04).

In the second slip power generation mode that is implemented at time T02 to T04, the first-clutch operation control section 45a controls the transfer torque of the first clutch C1 in the slip engagement state so as to transfer the torque according to the requested driving force Td for driving the wheels 15. That is, the first-clutch operation control section 45a performs torque control of the first clutch C1 by using the torque according to the position of the first clutch C1 on the power transmission path connecting the intermediate shaft M and the output shaft O as the target transfer torque capacity so that the requested driving force Td is transmitted to the wheels 15. In the illustrated example, the requested driving force Td is substantially zero. Accordingly, the first-clutch operation control section 45a performs torque control of the first clutch C1 by using the substantially zero torque (zero torque) as the target torque. In this case, the oil pressure command to the first clutch C1 corresponds to the disengagement boundary pressure.

The rotating-electrical-machine control section 43 performs rotational speed control of the rotating electrical machine 12 based on the target rotational speed Nmt. In this example, the target-rotational-speed setting section 43a sets the target rotational speed Nmt in the second slip power generation mode to a fixed value that is the rotational speed equal to the specific low vehicle-speed determination threshold value X2 and that does not change with time. The internal-combustion-engine control section 31 performs torque control of the internal combustion engine 11 in a manner similar to that in the parallel power generation mode.

In the second slip power generation mode, since the first clutch C1 is in the slip engagement state, the rotational speed of the rotating electrical machine 12 can be kept higher than the converted rotational speed Noc. Thus, the rotating electrical machine 12 rotating at such a rotational speed is caused to generate electricity, whereby the target power generation amount can be secured. In this case, since the starting clutch CS is in the direct engagement state rather than in the slip engagement state, the internal-combustion-engine torque Te can be transferred as it is to the rotating electrical machine 12 side. This can reduce energy loss in torque transmission via the starting clutch CS and can enhance power generation efficiency of the rotating electrical machine 12. Moreover, the differential rotational speed between engagement members on both sides of the starting clutch CS whose transfer torque is relatively large by an amount corresponding to the torque that is used to cause the rotating electrical machine 12 to generate electricity (hereinafter simply referred to as the “differential rotational speed of the starting clutch CS”) can be made equal to zero, and heat generation of the starting clutch CS can be suppressed. This can reduce the overall heat generation amount of the clutches CS, C1 as compared to the first slip power generation mode in which both the starting clutch CS and the first clutch C1 are in the slip engagement state. In particular, in the situation where torque control of the first clutch C1 is performed by using zero torque as the target torque as in this example, the total heat generation amount of the clutches CS, C1 can be reduced to substantially zero.

In the second slip power generation mode, with the converted rotational speed Noc being reduced, it is determined whether or not the differential rotational speed between the target rotational speed Nmt (equal to the specific low vehicle-speed determination threshold value X2) and the converted rotational speed Noc in the second slip power generation mode is equal to or higher than a preset set differential rotational speed ΔN1. If the differential rotational speed becomes equal to or higher than the set differential rotational speed ΔN1 at time T03, the drive mode is shifted from the second slip power generation mode to the first slip power generation mode. In this mode shift, the starting-clutch operation control section 44 gradually decreases an oil pressure that is supplied to the starting clutch CS (time T03 to T04). Slip start determination of the starting clutch CS is made in the state where the oil pressure that is supplied to the starting clutch CS is being gradually decreased (step #05).

The power generation/stop control section 46 makes slip start determination of the starting clutch CS based on whether or not the differential rotational speed of the starting clutch CS, namely the differential rotational speed between the internal combustion engine 11 and the rotating electrical machine 12 in this example becomes equal to or higher than a second slip start determination threshold value (second slip start determination threshold) Z2. If the differential rotational speed of the starting clutch CS becomes equal to or higher than the second slip start determination threshold value Z2 at time T04 (step #05: Yes), the mode shift from the second slip power generation mode to the first slip power generation mode is completed (step #06).

In the first slip power generation mode that is implemented from time T04, the first-clutch operation control section 45a performs torque control of the first clutch C1 in a manner similar to that in the second slip power generation mode. That is, the first-clutch operation control section 45a controls the transfer torque of the first clutch C1 in the slip engagement state so as to transfer the torque according to the requested driving force Td for driving the wheels 15. The internal-combustion-engine control section 31 performs torque control of the internal combustion engine 11 in a manner similar to that in the parallel power generation mode and the second slip power generation mode.

The starting-clutch operation control section 44 performs rotational speed control of the starting clutch CS by using the rotational speed equal to the specific low vehicle-speed determination threshold value X2 as the target rotational speed of the internal combustion engine 11. This allows the internal combustion engine 11 to continue self-sustained operation with generation of muffled noise and vibrations being suppressed, and the internal-combustion-engine torque Te that is output as a result of torque control of the internal combustion engine 11 is transferred as it is to the rotating electrical machine 12 side.

The rotating-electrical-machine control section 43 performs rotational speed control of the rotating electrical machine 12 based on the target rotational speed Nmt. The target-rotational-speed setting section 43a sets the target rotational speed Nmt in the first slip power generation mode to the rotational speed that is obtained by adding the predetermined set differential rotational speed ΔN1 to the converted rotational speed Noc. The set differential rotational speed ΔN1 is set based on the target power generation amount. That is, the set differential rotational speed ΔN1 is set as such a rotational speed that can secure the target power generation amount within the range of torque that can be output from the rotating electrical machine 12. Providing such a set differential rotational speed ΔN1 allows the actual rotational speed of the rotating electrical machine 12 to be kept significantly higher than the converted rotational speed Noc regardless of momentary variation in rotational speed of the output shaft O. Thus, the first clutch C1 can be reliably brought into the slip engagement state while securing the target power generation amount. In this example, as shown in FIG. 3, the target rotational speed Nmt gradually decreases with decrease in vehicle speed (or decrease in rotational speed of the output shaft O) at time T04 to T05. After the vehicle 6 is stopped at time T05, the target rotational speed Nmt is kept at the set differential rotational speed ΔN1. Even after time T05, the first slip power generation mode continues to be implemented even though the vehicle is stopped, and the stop/power generation mode is not implemented.

In the first slip power generation mode, the first clutch C1 continues to be in the slip engagement state as in the second slip power generation mode. Thus, the rotational speed of the rotating electrical machine 12 can be kept higher than the converted rotational speed Noc, and the target power generation amount can be secured. Since both the starting clutch CS and the first clutch C1 are in the slip engagement state, the differential rotational speed between engagement members on both sides of the first clutch C1 (hereinafter simply referred to as the “differential rotational speed of the first clutch C1”) can be reduced in the situation where the vehicle 6 is moved in the specific low vehicle-speed state while driving the internal combustion engine 11 at such a rotational speed that allows the internal combustion engine 11 to continue self-sustained operation as in the present embodiment. In particular, this example can reduce the differential rotational speed of the first clutch C1 as compared to the case where the starting clutch CS is in the direct engagement state and only the first clutch C1 is in the slip engagement state. This can suppress the heat generation amount of the first clutch C1.

In this example, the first slip power generation mode is continuously implemented even after the vehicle 6 is stopped. This is advantageous in that the vehicle 6 can be quickly started while causing the rotating electrical machine 12 to generate electricity if driver's starting operation (accelerator-on operation, brake-off operation, etc.) is detected subsequently.

In the mode shift from the second slip power generation mode to the first slip power generation mode, the starting clutch CS is transitioned from the direct engagement state to the slip engagement state as described above. This state transition of the starting clutch CS is made with the first clutch C1 being in the slip engagement state. This can suppress transmission of disengagement shock (direct-engagement release shock) in the state transition to the vehicle 6.

As described above, in the present embodiment, the power generation/stop control section 46 executes power generation/stop control to sequentially implement the parallel power generation mode, the second slip power generation mode, and the first slip power generation mode in this order with the vehicle 6 being decelerated. That is, the power generation/stop control section 46 shifts the drive mode from the parallel power generation mode to the second slip power generation mode as the vehicle speed decreases, and then shifts the drive mode from the second slip power generation mode to the first slip power generation mode as the vehicle speed further decreases. Accordingly, as described above, the target power generation amount can be secured, and a desired traveling state regarding the overall heat generation amount of the clutches CS, C1, the power generation efficiency of the rotating electrical machine 12, reduction in shock that is transmitted to the vehicle 6, etc. can be implemented according to the situation.

### 4. Other Embodiments

Lastly, other embodiments of the control device according to the present invention will be described. Configurations disclosed in each of the following embodiments can be combined with those disclosed in other embodiments as appropriate as long as no consistency arises.

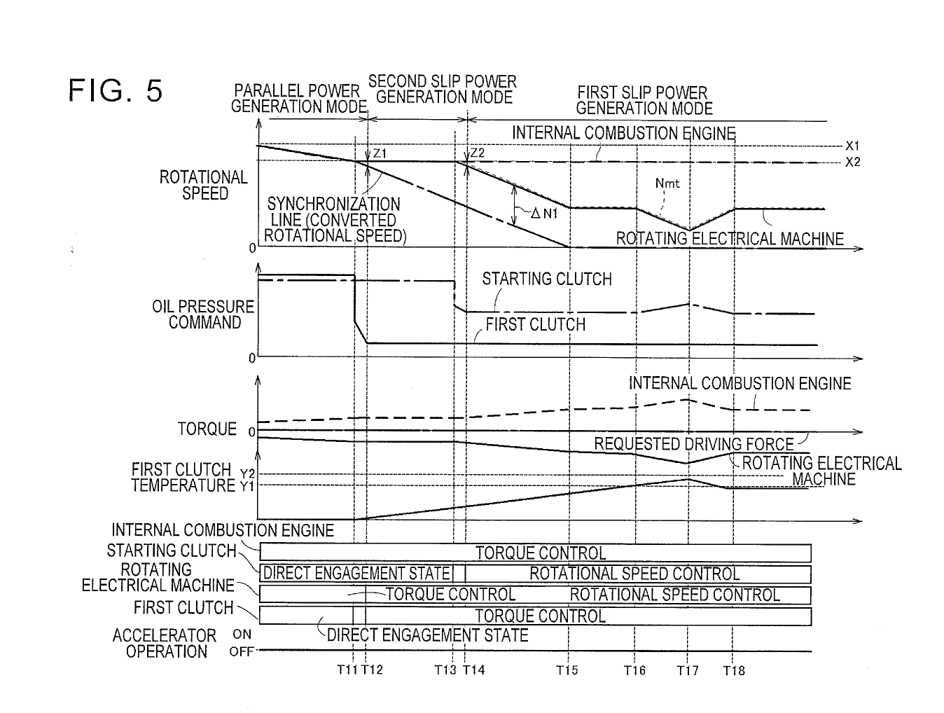

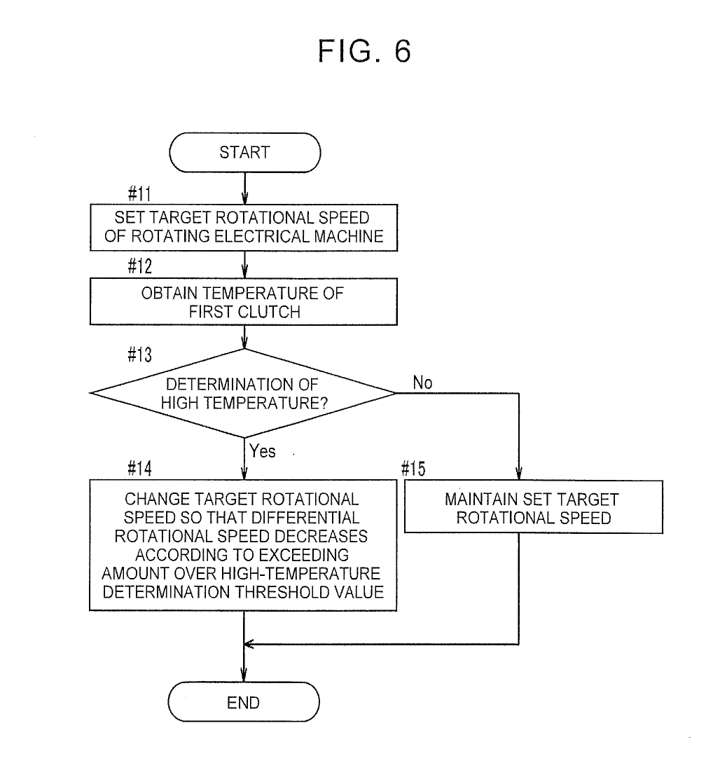

(1) In the above embodiment, it is also preferable to control the rotational speed of the rotating electrical machine 12 based also on the temperature of the first clutch C1 in a first slip power generation mode (see FIGS. 5 and 6). For example, in the state where rotational speed control of the rotating electrical machine 12 is performed based on the target rotational speed Nmt that is set as in the above embodiment (step #11), the rotational speed of the rotating electrical machine 12 may be controlled so as to reduce the differential rotational speed of the first clutch C1 if it is detected that the temperature of the first clutch C1 is getting close to an allowable upper limit temperature Y2. In this case, as shown by, e.g., a broken-line block in FIG. 1, the control device 4 includes a temperature-state monitoring section 51 that monitors the temperature of the first clutch C1. The temperature-state monitoring section 51 can directly obtain the temperature of the first clutch C1 based on, e.g., information from a clutch temperature sensor that detects the temperature of the first clutch C1. Alternatively, the temperature-state monitoring section 51 may calculate the heat generation amount of the first clutch C1 based on the transfer torque capacity and the differential rotational speed of the first clutch C1, and may obtain an estimated temperature of the first clutch C1 based on this heat generation amount. The temperature of the first clutch C1 may be obtained based on other known methods (step #12).

While the temperature of the first clutch C1 which is obtained by the temperature-state monitoring section 51 is less than a predetermined high-temperature determination threshold value (high-temperature determination threshold) Y1 (time T14 to T16, step #13: No), the target-rotational-speed setting section 43a maintains the target rotational speed Nmt that is set at that time (step #15). If the temperature of the first clutch C1 becomes equal to or higher than the high-temperature determination threshold value Y1 (from time T16, step #13: Yes), the target-rotational-speed setting section 43a changes (reduces) the target rotational speed Nmt so as to decrease the differential rotational speed between the rotational speed of the rotating electrical machine 12 and the converted rotational speed Noc. In this case, the target-rotational-speed setting section 43a changes the target rotational speed Nmt to a smaller value so as to decrease the differential rotational speed as the temperature of the first clutch C1 increases beyond the high-temperature determination threshold value Y1 (step #14). The above processing is sequentially repeatedly executed during execution of the power generation/stop control. This processing is herein referred to as the “overheat avoidance control.”

According to this overheat avoidance control, it can be detected based on the relation between the temperature of the first clutch C1 and the high-temperature determination threshold value Y1 that the first clutch C1 is getting closer to the overheat condition. If such a state is detected, the differential rotational speed of the first clutch C1 can be decreased to reduce the heat generation amount of the first clutch C1. In this case, as the amount by which the temperature of the first clutch C1 exceeds the high-temperature determination threshold value Y1 increases, the heat generation amount of the first clutch C1 can be more effectively reduced, and overheat of the first clutch C1 can be effectively suppressed. In the example shown in FIG. 5, by executing the overheat avoidance control, the temperature of the first clutch C1 starts decreasing at time T17 before reaching the allowable upper limit temperature Y2, and is eventually converged to a predetermined temperature lower than the high-temperature determination threshold value Y1. In the case where the amount by which the temperature of the first clutch C1 exceeds the high-temperature determination threshold value Y1 becomes relatively small such as in the case where the temperature of the first clutch C1 decreases subsequently as in this example, the amount of decrease in differential rotational speed of the first clutch C1 can be reduced. Accordingly, the differential rotational speed of the starting clutch CS is decreased while increasing the differential rotational speed of the first clutch C1 in such a range that overheat of the first clutch C1 does not particularly cause any problem, whereby the overall heat generation amount of the clutches CS, C1 can be reduced.

The target-rotational-speed setting section 43a may consistently decrease the differential rotational speed between the rotational speed of the rotating electrical machine 12 and the converted rotational speed Noc by a predetermined amount regardless of the amount by which the temperature of the first clutch C1 exceeds the high-temperature determination threshold value Y1. As described above, the temperature of the first clutch C1 can be estimated based on the heat generation amount of the first clutch C1. The overheat avoidance control is substantially the same even if, e.g., the temperature-state monitoring section 51 monitors the heat generation amount of the first clutch C1 instead of the temperature of the first clutch C1, and performs processing similar to that described above in the case where the heat generation amount becomes equal to or larger than a predetermined high heat-generation determination threshold value (high heat-generation determination threshold), and advantages similar to those described above can be obtained.

(2) The above embodiment is described with respect to an example in which the target-rotational-speed setting section 43a sets the rotational speed that is obtained by adding the set differential rotational speed ΔN1 to the converted rotational speed Noc to the target rotational speed Nmt in the first slip power generation mode. However, embodiments of the present invention are not limited to this. For example, the target-rotational-speed setting section 43a may set the target rotational speed Nmt based on a set rotational speed Np (not shown) that is preset to a value larger than the set differential rotational speed ΔN1, and the converted rotational speed Noc and the preset set differential rotational speed ΔN1. More specifically, the target-rotational-speed setting section 43a can set a higher one of the set rotational speed Np and the rotational speed that is obtained by adding the set differential rotational speed ΔN1 to the converted rotational speed Noc to the target rotational speed Nmt. Based on this target rotational speed Nmt, the rotating-electrical-machine control section 43 can perform rotational speed control of the rotating electrical machine 12 by using the rotational speed that is obtained by adding the set differential rotational speed ΔN1 to the converted rotational speed Noc as a first target, and can perform rotational speed control of the rotating electrical machine 12 by using the set rotational speed Np as a second target after the differential rotational speed between the set rotational speed Np and the converted rotational speed Noc becomes equal to or higher than the set differential rotational speed ΔN1.

The set rotational speed Np can be set based on, e.g., such a rotational speed that allows an oil pump drivingly coupled to the intermediate shaft M so as to rotate together therewith to secure a supply oil pressure that is required for all the engagement devices including the starting clutch CS and the first clutch C1. The set rotational speed Np may be set according to other purposes. In such a configuration, the rotational speed of the rotating electrical machine 12 can be kept at the set rotational speed Np or higher. By appropriately setting the set rotational speed Np according to various purposes, the rotational speed of the rotating electrical machine 12 can be kept at a rotational speed equal to or higher than the respective required rotational speed.

The target-rotational-speed setting section 43a may set the target rotational speed Nmt based on methods other than the method described in the above embodiment and the methods described above. Namely, any form can be used as a method for setting the target rotational speed Nmt in the rotational speed control of the rotating electrical machine 12.

(3) The above embodiment is described with respect to an example in which the power generation/stop control is executed when the vehicle is brought into the low vehicle-speed state during traveling in the parallel power generation mode and in the accelerator-off state. However, embodiments of the present invention are not limited to this. For example, the power generation/stop control may be executed when the vehicle is brought into the low vehicle-speed state during traveling in the parallel assist mode. Alternatively, even in the accelerator-on state, the power generation/stop control may be executed when the vehicle speed decreases and the vehicle is brought into the low vehicle-speed state. Alternatively, in these cases, the power generation/stop control may be executed only in a predetermined low power storage state (e.g., the state where the amount of electricity stored in the electricity storage device 28 is equal to or smaller than a predetermined low power-storage determination threshold value). The vehicle 6 does not have to be fully stopped, and may continue to travel at a very low speed in, e.g., the first slip power generation mode after the drive mode is sequentially shifted to the parallel power generation mode, the second slip power generation mode, and the first slip power generation mode. Alternatively, the vehicle 6 may be accelerated thereafter to continue to travel in other drive mode (e.g., the second slip power generation mode, the parallel power generation mode, etc.). In these cases, a series of processes for shifting the drive mode from the parallel power generation mode to the first slip power generation mode via the second slip power generation mode correspond to the “mode shift control” in the present invention.

(4) The above embodiment is described with respect to an example in which one of the engagement devices for shifting in the speed change mechanism 13 (first clutch C1) is the “second engagement device.” However, embodiments of the present invention are not limited to this. Any other engagement device in the speed change mechanism 13 which is provided on the output shaft O side with respect to the rotating electrical machine 12 on the power transmission path connecting the input shaft I and the output shaft O may be the “second engagement device.”

For example, in the case where a fluid coupling such as a torque converter is provided between the rotating electrical machine 12 and the output shaft O, a lockup clutch included in the fluid coupling may be the “second engagement device.” Alternatively, for example, a dedicated transmission clutch may be provided between the rotating electrical machine 12 and the output shaft O, and this transmission clutch may be the “second engagement device.” In these cases, an automatic stepless speed change mechanism, a manual stepped speed change mechanism, a fixed speed change mechanism, etc. may be used as the speed change mechanism 13. The speed change mechanism 13 can be placed at any position.

(5) The above embodiment is described with respect to an example in which the starting clutch CS and the first clutch C1 are hydraulically driven engagement devices whose engagement pressure is controlled according to the supplied oil pressure. However, embodiments of the present invention are not limited to this. The starting clutch CS and the first clutch C1 need only be able to adjust the transfer torque capacity (transfer torque) according to an increase or decrease in engagement pressure. For example, one or both of the starting clutch CS and the first clutch C1 may be an electromagnetic engagement device whose engagement pressure is controlled by the electromagnetic force.

(6) The above embodiment is described with respect an example in which the internal-combustion-engine control unit 30 that mainly controls the internal combustion engine 11, and the drive-device control unit 40 (control device 4) that mainly controls the rotating electrical machine 12, the starting clutch CS, and the speed change mechanism 13 are separately provided. However, the embodiments of the present invention are not limited to this. For example, a single control device 4 may control all of the internal combustion engine 11, the rotating electrical machine 12, the starting clutch CS, the speed change mechanism 13, etc. Alternatively, the control device 4 may further separately include a control unit that controls the rotating electrical machine 12, and a control unit that controls other various configurations. Assignment of the function sections described in the above embodiment is merely by way of example, and it is also possible to combine a plurality of function sections or to subdivide one function section.

(7) Regarding other configurations as well, the embodiments disclosed in the specification are by way of example only in all respects, and embodiments of the present invention are not limited to them. That is, those configurations which are not described in the claims of the present application may be modified as appropriate without departing from the object of the present invention.

The present invention can be applied to control devices that control a vehicle drive device including an internal combustion engine and a rotating electrical machine.

1-4. (canceled)

5. A control device that controls a vehicle drive device in which a first engagement device, a rotating electrical machine, a second engagement device, and an output member are sequentially provided from an internal combustion engine side on a power transmission path connecting an internal combustion engine and wheels, wherein
the control device executes mode shift control of shifting a mode from a first control mode in which the rotating electrical machine is caused to generate electricity with both the first engagement device and the second engagement device in a direct engagement state to a third control mode in which the rotating electrical machine is caused to generate electricity with both the first engagement device and the second engagement device in a slip engagement state via a second control mode in which the rotating electrical machine is caused to generate electricity with the first engagement device in the direct engagement state and the second engagement device in the slip engagement state.

6. The control device according to claim 5, wherein in the third control mode,
transfer torque of the second engagement device in the slip engagement state is controlled so that torque according to a requested driving force for driving the wheels is transferred, and
a rotational speed of the rotating electrical machine is controlled by using as a target rotational speed a rotational speed that is obtained by adding a predetermined set differential rotational speed to a converted rotational speed obtained by converting a rotational speed of the output member to a rotational speed obtained when the rotational speed of the output member is transmitted to the rotating electrical machine on an assumption that the second engagement device is in the direct engagement state.

7. The control device according to claim 6, wherein
if a temperature of the second engagement device becomes equal to or higher than a predetermined high-temperature determination threshold in the third control mode, the rotational speed of the rotating electrical machine is controlled so as to decrease a differential rotational speed between the converted rotational speed obtained by converting the rotational speed of the output member to the rotational speed obtained when the rotational speed of the output member is transmitted to the rotating electrical machine on the assumption that the second engagement device is in the direct engagement state and the rotational speed of the rotating electrical machine.

8. The control device according to claim 7, wherein
the differential rotational speed is reduced as the temperature of the second engagement device increases beyond the high-temperature determination threshold.

9. The control device according to claim 5, wherein
if a temperature of the second engagement device becomes equal to or higher than a predetermined high-temperature determination threshold in the third control mode, the rotational speed of the rotating electrical machine is controlled so as to decrease a differential rotational speed between the converted rotational speed obtained by converting the rotational speed of the output member to the rotational speed obtained when the rotational speed of the output member is transmitted to the rotating electrical machine on the assumption that the second engagement device is in the direct engagement state and the rotational speed of the rotating electrical machine.

10. The control device according to claim 9, wherein
the differential rotational speed is reduced as the temperature of the second engagement device increases beyond the high-temperature determination threshold.
